(19) United States
(12) Patent Application Publication
(10) Pub. No.: US 2024/0322489 A1
(43) Pub. Date: Sep. 26, 2024

(54) Plug With Interlock Contact, Plug Connection And Method For Making A Plug Connection

(71) Applicant: Lisa Dräxlmaier GmbH, Vilsbiburg (DE)

(72) Inventors: Maximilian FELIX, Siegsdorf (DE); Michael LEHMANN, Ingolstadt (DE)

(73) Assignee: Lisa Dräxlmaier GmbH, Vilsbiburg (DE)

(21) Appl. No.: 18/611,227

(22) Filed: Mar. 20, 2024

(30) Foreign Application Priority Data
Mar. 21, 2023 (DE) 10 2023 106 977.2

(51) Int. Cl. H01R 13/631; H01R 43/26

(52) U.S. Cl. CPC H01R 13/631; H01R 43/26

(57) ABSTRACT

A plug with an interlock contact is disclosed. The interlock contact is arranged on a movable contact locking element of the plug. The interlock contact is arranged in an intended mating position when the contact locking element is arranged in an intended locking position. The interlock contact is arranged in the plug-in position and is pluggably aligned with a mating contact of a header matching the plug when the plug is aligned with the header, and the interlock contact electrically contacts the mating contact when the plug is plugged together with the header.

### CROSS REFERENCE TO RELATED APPLICATIONS

This application claims priority to German Patent Application No. 10 2023 106 977.2, filed Mar. 21, 2023, the content of which is herein incorporated by reference.

### BACKGROUND OF THE INVENTION

### Field of the Invention

The present invention relates to a plug with an interlock contact, a plug connection and a method for producing a plug connection.

### Description of Related Art

The present invention is described below mainly in connection with high-voltage cables in electric vehicles.

Plug connections of a high-voltage electrical system of an electric vehicle can be protected by a safety circuit. The high-voltage (HV) vehicle electrical system is only energized when the safety circuit is closed. The safety circuit can be referred to as an HV interlock circuit and can run via an interlock contact at each plug connection. The interlock contact is closed electrically when the plug connection is plugged together.

The interlock contact can be integrated into a plug face of the plug connection. The interlock contact can be closed if the high-voltage contacts of the plug connection are already plugged together to a predefined extent in order to prevent arcing at the HV contacts. The interlock contact can be arranged in a fixed position relative to the high-voltage contacts so that the interlock contact can always close reliably.

### BRIEF SUMMARY OF THE INVENTION

One object of the presently described and claimed invention is therefore to provide an improved plug with interlock contact, an improved plug connection and an improved method for producing a plug connection, using means that are as simple as possible in terms of design. An improvement can, for example, relate to increased safety against incorrect operation of the plug connection.

In the approach presented here, the interlock contact is arranged on a locking element for the high-voltage contacts of a plug and can therefore be moved relative to the high-voltage contacts. A position of the interlock contact or the locking element indicates whether the high-voltage contacts are properly locked in the plug. If the high-voltage contacts are correctly locked, the locking element and thus also the interlock contact is in its intended position and can close the safety circuit when the plug is plugged together with a corresponding header.

With the approach presented here, the intended locking of the high-voltage contacts can be electrically monitored via the safety circuit in addition to a plugged-in state of the plug connection. This means that the high-voltage cables can only be put into operation if the high-voltage contacts are correctly locked. Even if the locking element is missing, i.e. the plug is incomplete, the safety circuit cannot be closed and the high-voltage vehicle electrical system cannot be activated.

According to a first aspect, a plug with an interlock contact is proposed, wherein the interlock contact is arranged on a movable contact locking element of the plug, wherein the interlock contact is arranged in an intended mating position when the contact locking element is arranged in an intended locking position, wherein the interlock contact arranged in the plug-in position is aligned in a pluggable manner with a mating contact of a header matching the plug when the plug is aligned with the header, and the interlock contact makes electrical contact with the mating contact when the plug is plugged together with the header.

According to a second aspect, a plug connection comprising a plug according to the first aspect and a corresponding header is proposed, wherein a movable contact locking element of the plug is arranged with an interlock contact of the plug in an intended locking position, wherein the interlock contact is arranged in a mating position, when the contact locking element is arranged in the locking position, wherein the plug is aligned with the header and is plugged together with the header, wherein the interlock contact arranged in the plug-in position is aligned with a mating contact of the header and makes electrical contact with the mating contact.

According to a third aspect, a method for producing a plug connection from a plug according to the first aspect and a corresponding header is proposed, wherein a movable contact locking element of the plug is arranged in an intended locking position, the plug is aligned with the header and is plugged together with the header, wherein an interlock contact of the plug arranged on the contact locking element is arranged in a mating position when the contact locking element is arranged in the locking position, the interlock contact arranged in the mating position is aligned with a mating contact of the header when the plug is aligned and makes electrical contact with the mating contact when it is mated.

An interlock contact can be part of a safety circuit for protecting an on-board electrical system. The vehicle electrical system can be a high-voltage vehicle electrical system and in particular be configured for automotive high-voltage up to 1500 volts. The safety circuit can run through all plug connections of the high-voltage vehicle electrical system to be protected. The safety circuit can be operated with a non-hazardous low-voltage, for example 12 volts. If one of the plug connections is interrupted, the safety circuit is also interrupted there and the vehicle electrical system is de-energized. This prevents contact with live high-voltage contacts.

The safety circuit can be interrupted before the high-voltage contacts are disconnected. This allows the vehicle electrical system to be de-energized before the high-voltage contacts are separated from each other. This prevents flashovers and electric arcs.

A plug can be part of a plug connection. In particular, the plug can be arranged at the end of a cable. The plug can be plugged together with a header to form the plug connection. The header can be referred to as a socket. The header can, for example, be arranged on an electrical component of the high-voltage vehicle electrical system. However, the header can also be located at the end of a cable. The plug and the header have mating plug geometries. The mating geometries define a mating direction of the plug connection via guide surfaces. The mating geometries can be essentially identical.

A contact locking element can be movably mounted in the plug. In a pre-engaged position of the contact locking element, high-voltage contacts of the plug can be inserted into corresponding contact chambers. In particular, the high-voltage contacts can be inserted into the contact chambers from behind. If the high-voltage contacts are arranged in the plug, the contact locking element can be moved into a locking position behind the high-voltage contacts, for example, and the high-voltage contacts can be locked/secured in the receptacles by a positive fit. In the locking position, the contact locking element can lock/secure at least one high-voltage contact of the plug in the plug as intended.

A contact locking element can be movably mounted in the plug. The contact locking element is fitted after the high-voltage contacts of the plug have been inserted into the corresponding contact chambers. In particular, the high-voltage contacts can be inserted into the contact chambers from behind. If the high-voltage contacts are arranged in the plug, the contact locking element can, for example, be mounted behind the high-voltage contacts in a locking position and the high-voltage contacts can be locked/secured by a positive fit in the receptacles or contact chambers. In the locking position, the contact locking element can lock/secure at least one high-voltage contact of the plug in the plug as intended.

A mating contact can be part of the safety circuit. The mating contact can, for example, be arranged in a fixed position in the header. The mating contact can be molded into the header, for example. The mating contact defines a mating position of the interlock contact. If the interlock contact is aligned with the mating contact, the interlock contact and the mating contact can be plugged together, i.e. they are pluggable. If the interlock contact is not aligned with the mating contact because the contact locking element is not in its intended locking position, the interlock contact and the mating contact cannot be plugged together and are therefore unpluggable. The interlock contact can be arranged unpluggably offset to the mating contact if the contact locking element is arranged in the pre-locking position.

Alternatively, the mating contact can be movable and arranged on a contact locking element of the header. The contact locking element of the header can have different kinematics to the contact locking element of the plug, so that the interlock contact and the mating contact can only be plugged in if both contact locking elements are arranged in the respective locking position.

The contact locking element can be movable transverse to the plug-in direction of the plug. The interlock contact can be moved sideways due to the mobility transverse to the plugging direction when the locking element is moved sideways. The maximum offset to the mating contact is transverse to the plugging direction if the locking element is not arranged in the locking position.

The contact locking element can block the plug from being plugged in when the contact locking element is in the pre-locking position. Alternatively or additionally, the part of the locking element that has the interlock contact can block the pluggability of the plug when the contact locking element is arranged in the pre-engagement position. The contact locking element can change the plug geometry of the plug if it is not arranged in the locking position. For example, the contact locking element can protrude laterally from at least one guide surface of the plug when it is not arranged in the locking position. In this case, the plug and the header can only be plugged together until the header abuts against the contact locking element. The header can then collide with the locking element.

The interlock contact can lag behind the high-voltage contact. A sequence of contact times can be defined by a lag. The high-voltage contacts of the plug can first have electrically conductive contact with mating parts in the header before the interlock contact touches the mating contact. This allows the high-voltage contacts to make metallic contact with the mating parts when the safety circuit is closed. Direct contact can reliably prevent flashovers and/or arcing when the high-voltage vehicle electrical system is activated.

The interlock contact can lead the high-voltage contact. A sequence of contact times can be defined by a leading contact. The high-voltage contacts of the plug can first disconnect the electrically conductive connection to the mating part in the header before the interlock contact disconnects the mating contact. This means that the high-voltage contacts cannot make metallic contact with the mating parts before the safety circuit is opened. By advancing the contact, flashovers and/or arcing can be safely prevented when the high-voltage wiring system is deactivated.

The at least one high-voltage contact can be latched in the plug via a primary contact locking device. The contact locking element can be moved into the locking position as a secondary contact fuse for the at least one high-voltage contact when the high-voltage contact is locked in the plug. The contact locking element can be provided as a second locking level.

The high-voltage contact can, for example, have at least one resilient latching lug that engages in the plug when the high-voltage contact is positioned in the plug. The latch can transfer mating forces to the plug when the plug and the header are plugged together. The contact securing element can be unloaded during mating when the high-voltage contacts are latched as intended.

The interlock contact can be designed as a bridge and electrically conductively connect the mating contact with at least one further mating contact of the header when the plug is plugged together with the header. The interlock contact can close a circuit, which has the mating contact and a further mating contact, when the plug and header are plugged together. The interlock contact designed as a bridge means that an extra line to the interlock contact along the cable and through the plug can be dispensed with. Alternatively, the interlock contact can also be connected via a safety line parallel to the cable. The interlock contact can then be connected in the plug via a flexible cable. Alternatively, the interlock contact can also contact a contact element in the plug when the contact locking element is moved into the locking position.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure. An advantageous embodiment of the present invention is set out below with reference to the accompanying figures, wherein:

FIG. 1 shows an illustration of a plug according to an embodiment example; and

FIG. 2 shows an illustration of a plug-in connection according to an embodiment example.

The figures are schematic representations and serve only to explain the invention. Identical or similarly acting elements are consistently provided with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including

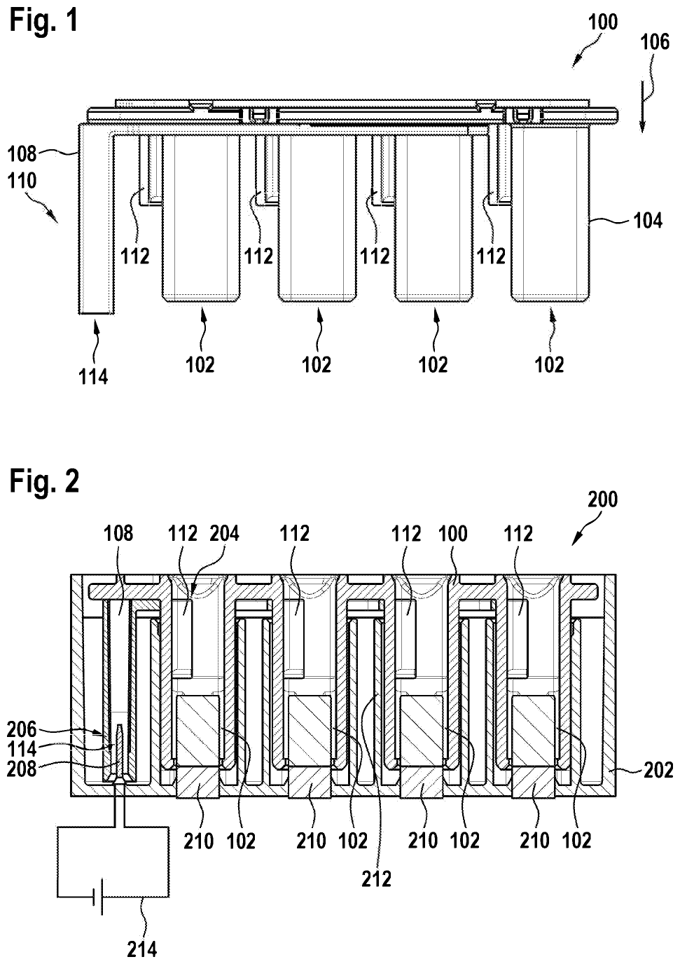

FIG. 1 shows an illustration of a plug 100 according to an example embodiment. The plug 100 is a connector for a high-voltage vehicle electrical system of an electric car. The plug 100 is intended to be arranged at the end of a high-voltage cable and to be plugged together with a suitable header in order to electrically conductively connect high-voltage lines of the high-voltage cable to another component of the high-voltage on-board electrical system. The connector 100 here has four contact chambers for high-voltage contacts 102 and is therefore designed to connect four high-voltage cables to the component.

Here, the high-voltage contacts 102 are arranged in a row next to each other. Each high-voltage contact 102 is arranged in its own dome of a mating geometry 104 of the plug 100. The mating geometry 104 specifies a mating direction 106 of the plug 100 by means of side surfaces of the domes aligned parallel to the mating direction 106.

The plug 100 has a movable contact locking element 108. The contact locking element 108 is movably mounted transversely to the plug-in direction 106. Here, the contact locking element 108 is shown in a pre-locking position 110. The contact locking element 108 can be moved laterally into a locking position. The contact locking element 108 has one latch 112 per dome. The latches 112 are designed to lock/secure the high-voltage contacts 102 in the domes in their intended positions when the contact locking element 108 is arranged in the locking position. When the latches 112 are in the locking position, the high-voltage contacts 102 cannot be pushed out of the domes against the plug-in direction 106 when they are plugged together with the header.

When the locking element 108 with the latches 112 is arranged in the pre-engagement position 110, the high-voltage contacts 102 can be inserted into the contact chambers from the rear in the insertion direction 106.

In the approach presented here, the contact locking element 108 has an interlock contact 114 of the plug 100. The interlock contact 114 is movable with the contact locking element 108. When the contact locking element 108 is arranged in the locking position, the interlock contact 114 is arranged in a mating position and can electrically contact a mating contact of the header.

In the state shown, the contact locking element 108 is arranged in the pre-locking position 110. This means that the interlock contact 114 is offset to the side of the mating position and cannot contact the mating contact.

In one embodiment example, the interlock contact 114 is arranged at the end of a dome of the contact locking element 108. The dome of the contact locking element 108 is aligned parallel to the domes of the plug 100 in the mating direction 106.

In one embodiment example, the latches 112 protrude laterally from the domes of the connector 100 when they are arranged in the pre-engagement position 110. If the side surfaces of the domes are interrupted by the latches 112, they interfere with the mating geometry 104. The plug 100 and the header cannot be mated if the latches 112 protrude from the side surfaces. The header would collide with the latches 112.

In an example embodiment, the contact fuse element 108 is designed as a secondary contact fuse and forms a fallback level if a primary contact fuse of at least one of the high-voltage contacts 102 fails. For primary contact protection, the high-voltage contacts 102 can, for example, engage in the contact chambers via a positive fit. For this purpose, each high-voltage contact 102 is held by at least one latching element, which is elastically deformed when the high-voltage contact 102 is inserted into the contact chamber and springs back into an initial position behind an undercut in the contact chamber or the high-voltage contact 102 in order to create a positive fit between the contact chamber and the high-voltage contact 102. The latching element can be arranged on the contact chamber or on the high-voltage contact 102. On the contact chamber, the latching element can be made, in particular, of a plastic material. On the high-voltage contact 102, the latching element can be made, in particular, of a metal material.

FIG. 2 depict an illustration of a plug connection 200 according to an embodiment example. A plug 100 is plugged into a header 202 on the plug connection 200. The plug 100 essentially corresponds to the plug in FIG. 1. In contrast to FIG. 1, the contact locking element 108 is arranged here in the locking position 204. The latches 112 of the contact locking element 108 lock the high-voltage contacts 102 in the domes. Since the contact locking element 108 is arranged in the locking position 204, the interlock contact 114 is also arranged in the intended mating position 206 and makes electrically conductive contact with the mating contact 208.

The high-voltage contacts 102 contact corresponding header contacts 210 of the header 202. In an example embodiment, the header contacts 210 are designed as blade contacts. The blade contacts are inserted into the high-voltage contacts 102. The high-voltage contacts 102 contact the header contacts 210 on both sides. Here, the blade contacts are arranged in a row and aligned with the row. Between the header contacts 210, the header 202 has protective collars 212, which define a mating geometry of the header 202 and serve as contact protection for the header contacts 210.

The mating contact 208 is also designed here as a blade contact. The mating contact 208 is aligned transversely to the header contacts 210. Due to this alignment, the interlock contact 114 can only make electrical contact with the mating contact 208 if it is arranged in the mating position 206. If the interlock contact 114 is arranged next to the plug-in position 206 because the contact locking element 108 is arranged outside the locking position 204, the interlock contact 114 does not make contact with the mating contact 108 and no electrically conductive connection is established.

In an example embodiment, the interlock contact 114 lags behind the high-voltage contacts 102. As a result, the high-voltage contacts 102 are already at least partially pushed onto the header contacts 210 before the interlock contact 114 touches the mating contact 208. If the high-voltage cables were activated directly in response to the electrically conductive contact between the interlock contact 114 and the mating contact 208, no flashover or arcing could occur because there is already an electrically conductive connection between the high-voltage contacts 102 and the header contacts 208.

In an example embodiment, the header 202 has two mating contacts 208. The mating contacts 208 are arranged next to each other. The interlock contact 114 is so large that it contacts both mating contacts 208 and thus bridges them. The interlock contact 114 connects the mating contacts 208 in an electrically conductive manner when the plug connection 200 is plugged together. Here, a safety circuit 214 of the high-voltage vehicle electrical system can run via both mating contacts 208 and be closed when the interlock contact 114 connects the mating contacts 208. This makes it possible to dispense with a line-parallel signal cable for the safety circuit 214.

Interlock protection by means of secondary locking is presented hereinbelow.

The approach presented here can improve human protection against misuse and incorrect processing when operating the connector with interlock.

In the case of connectors, an integrated signal line in the connector, which releases the circuit (interlock, e.g. in HV connector systems), can be used to check that the final position of a locking element (e.g. second contact fuse) has been reached. This can also be checked in the EOL (End of Line). This refers to plugs with at least one existing current path that must be protected. In this way, misuse during/after assembly and maintenance can be ruled out. Misuse can be a missing secondary interlock, for example, or if this would be removed again in any case after the EOL test.

By integrating/mounting relevant components for a signal circuit (e.g. HV interlock) on/at the interlock (e.g. secondary interlock), the signal circuit is only closed (in the mated state) when the interlock is in the end position. This allows an interlock to be monitored electronically.

If the interlock is missing, the signal circuit is not closed due to missing relevant components. If the interlock is not in the end position, the plug cannot be plugged into the end position and the signal circuit is therefore also not closed.

Traditionally, the interlock is always integrated in the inner housing. This means that the plug can sometimes still be plugged in, even if the second contact fuse is not fully engaged. This can be prevented mechanically, but these plugs can still be plugged in by active manipulation (removing the second contact fuse). In both cases, the plug can be used in an unsafe condition.

The approach presented here can be used with all connector systems that include an electronic signal circuit and some form of latching.

The approach presented here enables protection against abuse.

In the approach presented here, the interlock is integrated in the second contact fuse.

FIG. 1 shows the second contact fuse in the pre-engaged position with the inner housing.

In connection with the interface/header (shown in FIG. 2), the interlock does not hit the male/female pins of the interface if the second contact fuse is in the pre-engaged position. The connection between the interface/header and the plug is not released. The plug cannot be plugged in either, as the second contact fuse collides with the interface/header at one or more points, but even if the second contact fuse is removed or forgotten to be fitted, the connection (function of the interlock) cannot be released.

In FIG. 2, the second contact lock is in the end latched position. The contacts must be fully latched so that the second contact lock can be latched. A definition of complete latching is specified by the contact & chamber developer and checked for each connector in the PG6.4 test in accordance with LV214. FIG. 2 shows that the interlock pins of the interface/header enter the chamber of the interlock. The interlock bridge, which is inserted in the interlock cavity, is not shown here for the sake of clarity.

Since the devices and methods described in detail above are examples of embodiments, they can be modified to a wide extent by a person skilled in the art without departing from the scope of the invention. In particular, the mechanical arrangements and the proportions of the individual elements to one another are merely exemplary.

What is claimed is:

1. A plug comprising:
an interlock contact;
a movable contact locking arrangement,
with interlock contact arranged on a movable contact locking element of the plug,
wherein the interlock contact is arranged in an intended mating position when the contact locking element is arranged in an intended locking position,
wherein the interlock contact arranged in the plug-in position is aligned, via a plugging arrangement, with a mating contact of a header matching the plug when the plug is aligned with the header, and
the interlock contact electrically contacts the mating contact when the plug is plugged together with the header.

2. The plug according to claim 1, wherein the contact locking element is movable transversely to a plugging direction of the plug.

3. The plug according to claim 1, wherein the interlock contact is arranged unplugged and offset from the mating contact when the contact locking element is arranged in a pre-engagement position.

4. The plug according to claim 1, wherein the contact locking element blocks a pluggability of the plug when the contact locking element is arranged in a pre-engagement position.

5. The plug according to claim 1, wherein the contact locking element in the locking position is configured to lock at least one high-voltage contact of the plug in the plug.

6. The plug according to claim 5, wherein the interlock contact lags or leads the high-voltage contact.

7. The plug according to claim 5, wherein:
the high-voltage contact is latched in the plug via a primary contact locking device, and
the contact locking element is arranged and configured to be displaced into the locking position as a secondary contact locking device when the high-voltage contact is latched in the plug.

8. The plug according to claim 1, wherein the interlock contact is configured as a bridge and to electrically conductively connect the mating contact to at least one further mating contact of the header when the plug is plugged together with the header.

9. A plug connection comprising:
a plug comprising an interlock contact, a movable contact locking arrangement, wherein: the interlock contact is arranged on a movable contact locking element of the plug, the interlock contact is arranged in an intended mating position when the contact locking element is arranged in an intended locking position; and the interlock contact arranged in the plug-in position is aligned, via a plugging arrangement, with a mating contact of a header matching the plug when the plug is aligned with the header; and the interlock contact electrically contacts the mating contact when the plug is plugged together with the header; and
a corresponding header,
wherein the movable contact locking element of the plug is arranged with an interlock contact of the plug in an intended locking position,
wherein the interlock contact is arranged in a plug-in position when the contact locking element is arranged in the locking position,
wherein the plug is aligned with the header and is plugged together with the header, and
wherein the interlock contact arranged in the plug-in position is aligned with a mating contact of the header and electrically contacts the mating contact.

10. A method for producing a plug connection from a plug and a corresponding header, the plug comprising an interlock contact, a movable contact locking arrangement, wherein: the interlock contact is arranged on a movable contact locking element of the plug, the interlock contact is arranged in an intended mating position when the contact locking element is arranged in an intended locking position; and the interlock contact arranged in the plug-in position is aligned, via a plugging arrangement, with a mating contact of a header matching the plug when the plug is aligned with the header; and the interlock contact electrically contacts the mating contact when the plug is plugged together with the header, the method comprising the steps of:
arranging a movable contact locking element of the plug in an intended locking position,
aligning the plug with the header,
plugging the plug together with the header,
arranging an interlock contact of the plug, arranged on the contact locking element, in a mating position when the contact locking element is arranged in the locking position, and
aligning the interlock contact, arranged in the mating position, with a mating contact of the header when the plug is aligned and electrically contacts the mating contact when the plug is mated.
